(19) United States
(12) Patent Application Publication
(10) Pub. No.: US 2020/0234898 A1
(43) Pub. Date: Jul. 23, 2020

(54) BREAKER AND SAFETY CIRCUIT EQUIPPED WITH THE SAME

(71) Applicant: BOURNS KK, Osaka (JP)

(72) Inventor: Masashi Namikawa, Osaka (JP)

(21) Appl. No.: 16/652,969

(22) PCT Filed: Sep. 27, 2018
(86) PCT No.: PCT/JP2018/035943

§ 371 Date: Apr. 1, 2020

(30) Foreign Application Priority Data
Oct. 4, 2017 (JP) 2017-194524

(51) Int. Cl. H01H 37/04; H01H 37/54; H01M 10/42

(52) U.S. Cl. CPC H01H 37/043; H01H 2037/046; H01M 10/4257; H01H 37/54

(57) ABSTRACT

A breaker has a movable piece which has an elastic part elastically deformable and a moving contact in one end portion of the elastic part, and which presses the moving contact against the fixed contact so that the moving contact contacts with the fixed contact; a thermally-actuated element deforming with a change in the temperature to actuate the movable piece so that the moving contact is separated from the fixed contact; a case housing the movable piece and the thermally-actuated element; and a terminal piece to be connected to an external circuit. The case has a side wall extending along a longitudinal direction of the elastic part. The terminal piece has a protruding portion which protrudes from the side wall toward the outside of the case. The side wall is provided, in its neighboring portion of the protruding portion, with a concave portion which dents inwardly of the case.

### TECHNICAL FIELD

The present invention relates to a minisize breaker or the like built into a secondary battery pack or the like of an electrical equipment.

### BACKGROUND ART

Conventionally, a breaker has been used as a protection device (safety circuit) for a secondary battery, a motor and the like of various electrical equipments. When an abnormality occurs, e.g. when the temperature of a secondary battery during charging/discharging rises excessively, or when an overcurrent flows through a motor or the like installed in an equipment of an automobile, a home appliance and the like, the breaker cuts off the current to protect the secondary battery, motor and the like. The breaker used as such a protection device is required to operate accurately (to have good temperature characteristics) in accordance with temperature changes in order to ensure the safety of the equipment as well as to have a stable resistance value when flowing the current.

The breaker is provided with a thermally-actuated element which, according to the temperature changes, operates to turn on or turn off the current. Patent Document 1 discloses a breaker using a bimetal as a thermally-actuated element. A bimetal is an element, which is formed by laminating two types of plate-like metal materials having different coefficients of thermal expansion, and which changes its shape according to the temperature change to control the conduction state of the contacts. The breaker disclosed in this document is formed by housing in a case, a fixed piece, a terminal piece, a movable piece, a thermally-actuated element, a PTC thermistor and the like, and terminals of the fixed piece and terminal piece protrude from the case to be connected to an electric circuit of an equipment to use the breaker.

### PRIOR ART DOCUMENT

### Patent Document

Patent Document 1: Japanese Patent Application Publication No. 2016-035822

### SUMMARY OF THE INVENTION

### Problem to be Solved by the Invention

On the other hand, when a breaker is used as a protection device for a secondary battery provided in an electrical equipment, e.g. a notebook size personal computer, a tablet type portable information terminal device, a thin multifunctional mobile phone called smartphone and the like, miniaturization is required for the breaker in addition to the safety as described above. In recent years, users have a strong desire for miniaturization (thinness) of portable information terminal devices, therefore, devices newly launched on the market by various manufacturers have a pronounced tendency to be designed to be small in order to ensure superiority in the design. Against this background, a breaker which is mounted together with a secondary battery as a component of a portable information terminal device is also strongly required to be further miniaturized.

The present invention was made to solve the above-described problem, and an object thereof is to provide a breaker which can be easily miniaturized.

### Means for Solving the Problem

In order to achieve the above object, in the present invention, a breaker comprises
a fixed contact,
a movable piece which has an elastic part formed in a plate shape and elastically deformable and a moving contact in one end portion of the elastic part, and which presses the moving contact against the fixed contact so that the moving contact contacts with the fixed contact,
a thermally-actuated element deforming with a change in the temperature to actuate the movable piece so that the moving contact is separated from the fixed contact,
a case housing the movable piece and the thermally-actuated element, and
a terminal piece to be electrically connected to an external circuit, and is characterized in that
the case has a side wall extending along a longitudinal direction of the elastic part,
the terminal piece has a protruding portion which protrudes from the side wall toward the outside of the case, and
the side wall is provided, in its neighboring portion of the protruding portion, with a concave portion which dents inwardly of the case.

In the breaker according to the present invention, it is desirable that the protruding portion is disposed on each side in the longitudinal direction with respect to the thermally-actuated element.

In the breaker according to the present invention, it is desirable that the side wall is provided, in its neighboring portion of the thermally-actuated element, with a convex portion protruding outwardly of the case from the concave portion.

In the breaker according to the present invention, it is desirable that the case includes a first case provided with a housing recess for accommodating the movable piece and the thermally-actuated element, and a second case attached to the first case and covering the housing recess, and the concave portion is formed on the first case.

In the breaker according to the present invention, it is desirable that the side wall of the second case is formed in a planar shape.

In the breaker according to the present invention, it is desirable that the concave portion dents inwardly of the case from the side wall of the second case.

In the breaker according to the present invention, it is desirable that the concave portion and the housing recess each have an recessed corner portion in a fillet shape, and a radius of curvature of the recessed corner portion of the housing recess is larger than a radius of curvature of the recessed corner portion of the concave portion.

In the breaker according to the present invention, it is desirable that a leading end of the protruding portion and a leading end of the convex portion are positioned on the same plane parallel to the longitudinal direction.

In the breaker according to the present invention, it is desirable that the case is formed in a rectangular shape having long sides in the longitudinal direction of the elastic part when viewed in the thickness direction of the elastic part, and the concave portion is disposed in a corner portion of the case.

A safety circuit for an electrical equipment according to the present invention includes the breaker.

### Effects of the Present Invention

In the breaker according to the present invention, the case has the side wall extending along the longitudinal direction of the elastic part, and the terminal piece has the protruding portion protruding outwardly of the case from the side wall. In other words, the protruding portion protrudes from the side wall in the short direction of the elastic part, and it can be connected to an external circuit. Thereby, the length dimension of the breaker in the longitudinal direction is controlled, and the breaker can be miniaturized.

In addition, the side wall has the concave portion denting inwardly of the case around the protruding portion. Thereby, the length in the short direction is controlled while ensuring the amount of protrusion of the protruding portion from the side wall, therefore, the breaker can be miniaturized.

### BRIEF EXPLANATION OF THE DRAWINGS

FIG. 1 A perspective view showing a rough structure of a breaker as an embodiment of the present invention before assembling.

FIG. 2 A cross-sectional view showing the breaker in a normal charge/discharge state.

FIG. 3 A cross-sectional view showing the breaker in an overcharge state or at the time of abnormality.

FIG. 4 A perspective view showing the exterior configuration of the breaker.

FIG. 5 A perspective view showing a case main body in which the thermally-actuated element and the movable piece have been sequentially mounted, but the lid is not yet mounted.

FIG. 6 A top view enlargedly showing the concave portion of the case main body and the neighboring portion thereof.

FIG. 7 A perspective view of the breaker viewed from its bottom side.

FIG. 8 A top view of the breaker.

FIG. 9 A circuit diagram of a safety circuit having the breaker of the present invention.

### MODE FOR CARRYING OUT THE INVENTION

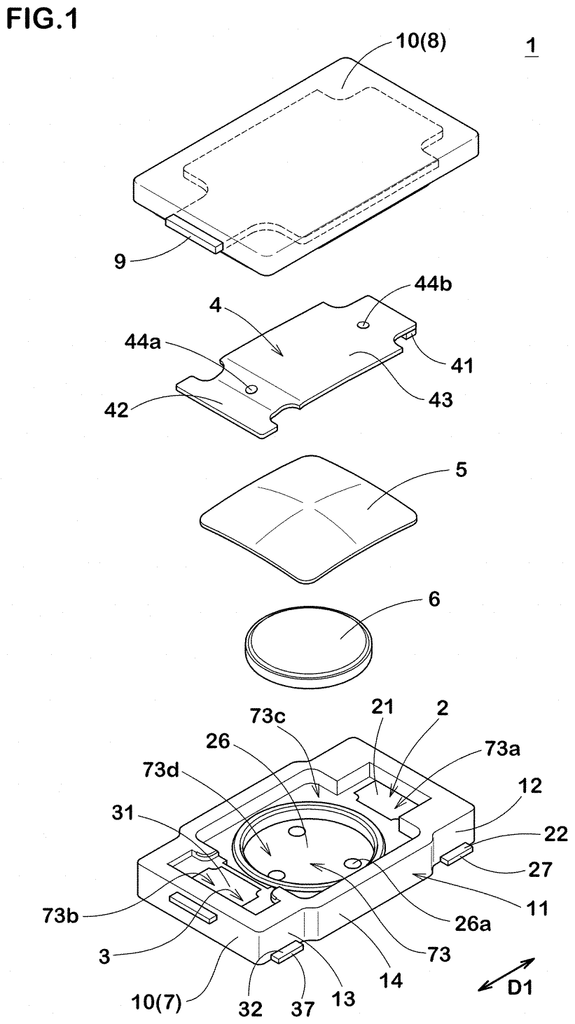

A breaker as an embodiment of the present invention will be described with reference to the drawings. FIGS. 1 to 3 show the configuration of the breaker. The breaker 1 has a pair of terminal pieces 2 and 3 partially exposed to the outside of a case 10. When the terminal pieces 2 and 3 are electrically connected to an external circuit (not shown), the breaker 1 constitutes a main part of a safety circuit of an electrical equipment.

As shown in FIG. 1, the breaker 1 is composed of a terminal piece 2 having a fixed contact 21 and a terminal 22, a terminal piece 3 having a terminal 32, a movable piece 4 having a moving contact 41 at its tip end, a thermally-actuated element 5 deforming with a temperature change, a PTC (positive temperature coefficient) thermistor 6, a case 10 for accommodating the terminal piece 2, the terminal piece 3, the movable piece 4, the thermally-actuated element 5, and the PTC thermistor 6, and the like. The case 10 is composed of a case main body (first case) 7, a lid member (second case) 8 mounted on the upper surface of the case main body 7, and the like.

The terminal piece 2 is formed by, for example, pressing a metal plate containing copper or the like as a main component (in addition, metal plates of copper-titanium alloy, nickel silver, brass, and the like), and is embedded in the case main body 7 by insert molding.

The fixed contact 21 is formed by cladding, plating or coating a material having good conductivity, e.g. silver, nickel and a nickel-silver alloy as well as a copper-silver alloy, a gold-silver alloy and the like. The fixed contact 21 is formed in an opposed position to the moving contact 41, and is exposed to a housing recess 73 of the case main body 7 from a part of an opening 73a formed inside the case main body 7.

In this application, unless otherwise noted, the surface of the terminal piece 2 on which the fixed contact 21 is formed (i.e., the upper surface in FIG. 1) is described as a first surface, and the opposite bottom surface as a second surface. The same applies to other parts, for example, the terminal piece 3, the movable piece 4, the thermally-actuated element 5, the case 10, a metal plate 9, and the like.

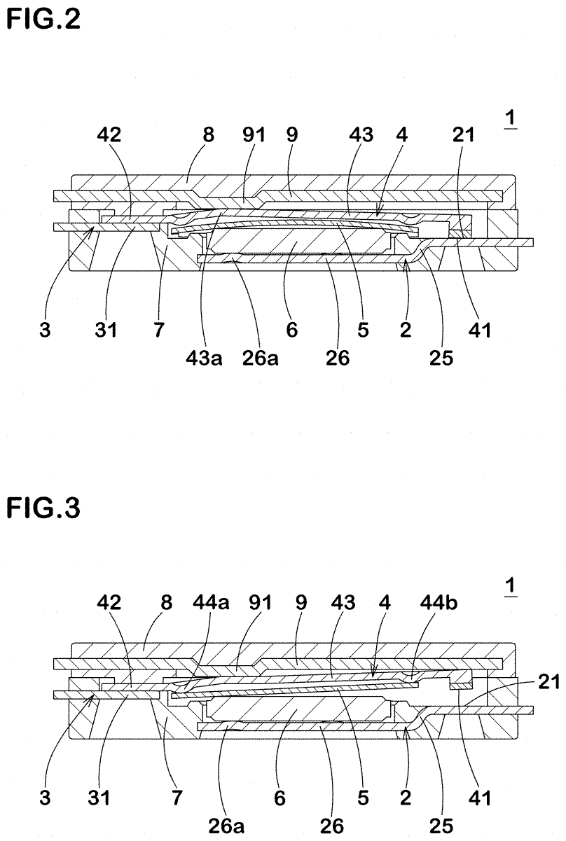

As shown in FIG. 2, the terminal piece 2 has a stepwise bent portion 25 bent in a step shape (a crank shape in its side view), and a support portion 26 supporting the PTC thermistor 6. The stepwise bent portion 25 connects the fixed contact 21 and the support portion 26, and arranges the fixed contact 21 and the support portion 26 at different heights. The stepwise bent portion 25 is embedded in the case main body 7. The PTC thermistor 6 is placed on three protrusions (DABO [sic]) 26a formed at three places in the support portion 26, and is supported by the protrusions 26a.

The terminal piece 3 is formed by pressing a metal plate mainly composed of copper or the like similarly to the terminal piece 2, and is embedded in the case main body 7 by insert molding. The terminal piece 3 has a terminal 32 and a connect portion 31 connected to the movable piece 4.

The connect portion 31 is exposed to the housing recess 73 of the case main body 7 from a part of the opening 73b formed inside the case main body 7, and is electrically connected to the movable piece 4.

The movable piece 4 is formed by pressing a plate-shaped metal material mainly containing copper or the like. The movable piece 4 is formed in an arm shape symmetric about the center line in the longitudinal direction.

The moving contact 41 is formed in one of end portions of the movable piece 4. The moving contact 41 is formed on the second surface of the movable piece 4 by the same material as the fixed contact 21, and is united with the tip end portion of the movable piece 4 through a technique of welding as well as cladding, crimping (crimping) or the like.

At the other of the end portions of the movable piece 4, there is formed a connect portion 42 electrically connected to the connect portion 31 of the terminal piece 3. The first surface of the connect portion 31 of the terminal piece 3 is fixed to the second surface of the connect portion 42 of the movable piece 4 by laser welding. The laser welding is a welding method of irradiating a laser beam to works (in the present embodiment, corresponding to the terminal piece 3 and the movable piece 4) and locally melting and then solidifying the work to join the works together. On the surface of the work irradiated with the laser beam, there is formed a laser welding mark different in form from a welding mark formed by another welding method (for example, resistance welding using Joule heat)

The movable piece 4 has an elastic part 43 between the moving contact 41 and the connect portion 42. The elastic part 43 extends from the connect portion 42 toward the moving contact 41. Thus, the connect portion 42 is provided on the opposite side of the moving contact 41 across the elastic part 43.

The movable piece 4 is fixed in the connect portion 42 by being fixed to the connect portion 31 of the terminal piece 3, and is elastically deformable in the elastic part 43, and thereby the moving contact 41 formed in the tip end portion thereof is pressed against the fixed contact 21 and comes into contact with it, so electrical current can flow through the terminal piece 2 and the movable piece 4. As the movable piece 4 and the terminal piece 3 are electrically connected at the connect portion 31 and the connect portion 42, electrical current can flow through the terminal piece 2 and the terminal piece 3.

The movable piece 4 is curved or bent in the elastic part 43 by press working. The degree of curving or bending is not particularly limited as long as the thermally-actuated element 5 can be housed, and may be appropriately set in consideration of the elastic force at the operating temperature and the reset temperature, the pressing force of the contact, and the like. On the second surface of the elastic part 43, a pair of protrusions (contact portions) 44a and 44b are formed to oppose to the thermally-actuated element 5. The protrusions 44a and 44b come into contact with the thermally-actuated element 5, and the deformation of the thermally-actuated element 5 is transmitted to the elastic part 43 via the protrusions 44a and 44b (see FIGS. 1 and 3).

The thermally-actuated element 5 shifts its state from a conducting state in which the moving contact 41 contacts with the fixed contact 21 to a cut-off state in which the moving contact 41 is separated from the fixed contact 21. The thermally-actuated element 5 is formed by laminating thin plates having initial shapes curved in an arc shape, and having different coefficients of thermal expansion. When the operating temperature is reached due to overheating, the curved shape of the thermal-actuated element 5 reversely warps with snap motion, and when the temperature is decreased below the reset temperature due to cooling, it is restored. The initial shape of the thermally-actuated element 5 can be formed by press working. As long as the elastic part 43 of the movable piece 4 is pushed up by the reverse warping motion of the thermally-actuated element 5 at the intended temperature, and is restored by the elastic force of the elastic part 43, the material and the shape of the thermally-actuated element 5 are not limited particularly. But, a rectangular shape is desirable from the viewpoint of productivity and efficiency of the reverse warpage motion, and a rectangle close to a square is desirable in order to efficiently push up the elastic part 43 in spite of its small size.

As the materials of the thermally-actuated element 5, two kinds of materials having different coefficients of thermal expansion, which are made of various alloys such as nickel silver, brass, stainless steel, etc., are laminated and used in combination according to required conditions. For example, preferred as the materials of the thermally-actuated element 5 which can obtain a stable operating temperature and a reset temperature, is a combination of a copper-nickel-manganese alloy on the high expansion side and an iron-nickel alloy on the low expansion side. Further, materials more preferred from the viewpoint of chemical stability, include a combination of an iron-nickel-chromium alloy on the high expansion side and an iron-nickel alloy on the low expansion side. Furthermore, materials more preferred from the viewpoints of chemical stability and workability, include a combination of an iron-nickel-chromium alloy on the high expansion side and an iron-nickel-cobalt alloy on the low expansion side.

When the movable piece 4 is in the cut-off state, the PTC thermistor 6 conducts between the terminal piece 2 and the movable piece 4. The PTC thermistor 6 is disposed between the support portion 26 of the terminal piece 2 and the thermally-actuated element 5. That is, the support portion 26 is located directly below the thermally-actuated element 5 with the PTC thermistor 6 interposed therebetween. When the current flow of the terminal piece 2 and the movable piece 4 is interrupted by the reverse warpage motion of the thermally-actuated element 5, the current flowing through the PTC thermistor 6 increases. As to the PTC thermistor 6, various types of positive temperature coefficient thermistor can be selected according to the operating current, the operating voltage, the operating temperature, the reset temperature, etc. as needed basis as long as it can limit the current by increasing the resistance value as the temperature rises, and the materials and the shape are not particularly limited as long as those properties are not impaired. In this embodiment, a ceramic sintered body including barium titanate, strontium titanate, or calcium titanate is used. In addition to the ceramic sintered body, a so-called polymer PTC in which a polymer contains conductive particles such as carbon may be used.

The case 10 is formed in a rectangular shape whose long sides are in the longitudinal direction D1 of the elastic part 43 (that is, the direction from the connect portion 42 side to the moving contact side) when viewed in the thickness direction of the elastic part 43 of the movable piece 4. The longitudinal direction D1 of the elastic part 43 matches the longitudinal direction of the case 10 (hereinafter, both are referred to as the longitudinal direction D1).

The case main body 7 and the lid member 8 constituting the case 10 are molded from thermoplastic resins, e.g. flame-retardant polyamide, heat-resistant polyphenylene sulfide (PPS), liquid crystal polymer (LCP), polybutylene terephthalate (PBT) and the like. Materials other than resins may be used as long as characteristics equivalent to or higher than those of the resins described above can be obtained.

The case main body 7 is provided with a housing recess 73 which is an internal space for accommodating the movable piece 4, the thermally-actuated element 5, the PTC thermistor 6 and the like. The housing recess 73 has openings 73a and 73b for housing the movable piece 4, an opening 73c for housing the movable piece 4 and the thermally-actuated element 5, an opening 73d for housing the PTC thermistor 6, and the like. The edges of the movable piece 4 and the thermally-actuated element 5 mounted in the case main body 7 are respectively abutted by rims formed on the inside of the housing recess 73 and guided when the thermally-actuated element 5 makes the reverse warpage motion.

In the lid member 8, a metal plate 9 is embedded by insert molding. The metal plate 9 is formed by pressing the above-mentioned metal plate containing copper or the like as its main component, or a metal plate of a stainless steel and the like. The metal plate 9 appropriately contacts the first surface of the movable piece 4 as shown in FIGS. 2 and 3 to regulate the movement of the movable piece 4, and at the same time, increases the rigidity and strength of the lid member 8, consequently, of the case 10 as a housing, contributing to the downsizing of the breaker 1.

As shown in FIG. 1, the lid member 8 is attached to the case main body 7 so as to close the openings 73a, 73b, 73c, etc. of the case main body 7 containing the terminal piece 2, the terminal piece 3, the movable piece 4, the thermally-actuated element 5, the PTC thermistor 6 and the like. The case main body 7 and the lid member 8 are joined by, for example, ultrasonic welding. At this time, the case main body 7 and the lid member 8 are continuously joined over the respective entire peripheral edges, and the airtightness of the case 10 is improved. Thereby, the internal space of the case 10 provided by the housing recess 73 is sealed, and the parts such as the movable piece 4, the thermally-actuated element 5 and the PTC thermistor 6 can be shielded and protected from the atmosphere outside the case 10. In the present embodiment, since the resin is disposed entirely on the first surface side of the metal plate 9, the airtightness of the housing recess 73 is further enhanced.

FIG. 2 shows the operational state of breaker 1 in a normal charge/discharge state. In the normal charge/discharge state, the thermally-actuated element 5 maintains its initial shape (before reverse warpage). The metal plate 9 is provided with a protruding portion 91 which comes into contact with a top 43a of the movable piece 4 and presses the top 43a toward the thermally-actuated element 5. When the protruding portion 91 presses the top 43a, the elastic part 43 is elastically deformed, and the moving contact 41 formed at the tip end portion thereof is pressed against the fixed contact 21 to come into contact therewith. As a result, conduction is established between the terminal piece 2 and the terminal piece 3 of the breaker 1 through the elastic part 43 of the movable piece 4 and the like. The elastic part 43 of the movable piece 4 may come into contact with the thermally-actuated element 5, to establish conduction through the movable piece 4, the thermally-actuated element 5, the PTC thermistor 6 and the terminal piece 2 as a circuit. However, as the resistance of the PTC thermistor 6 is overwhelmingly higher than the resistance of the movable piece 4, the current flowing through the PTC thermistor 6 is a substantially negligible degree as compared to the amount flowing through the fixed contact 21 and the moving contact 41.

FIG. 3 shows the operational state of the breaker 1 in an overcharged state or an abnormal state. When becoming a high temperature state due to overcharging or an abnormality, the thermally-actuated element 5 which has reached the operating temperature, reversely warps, and pushes up the elastic part 43 of the movable piece 4, and the fixed contact 21 and the moving contact 41 are separated. The operating temperature of the thermally-actuated element 5 at which the movable-element 5 is deformed in the interior of the breaker 1 and the movable piece 4 is pushed up, is from 70 degrees C. to 90 degrees C., for example. At this time, the current flowing between the fixed contact 21 and the moving contact 41 is interrupted, and a slight leakage current flows through the thermally-actuated element 5 and the PTC thermistor 6. The PTC thermistor 6 continues to generate heat as long as such leakage current flows, and maintains the thermally-actuated element 5 in the reverse warped state to drastically increase the resistance value. Therefore, the current does not flow through a path between the fixed contact 21 and the moving contact 41, and only the slight leakage current described above exists (this constitutes a self-holding circuit). The leakage current can be used for other functions of the safety device.

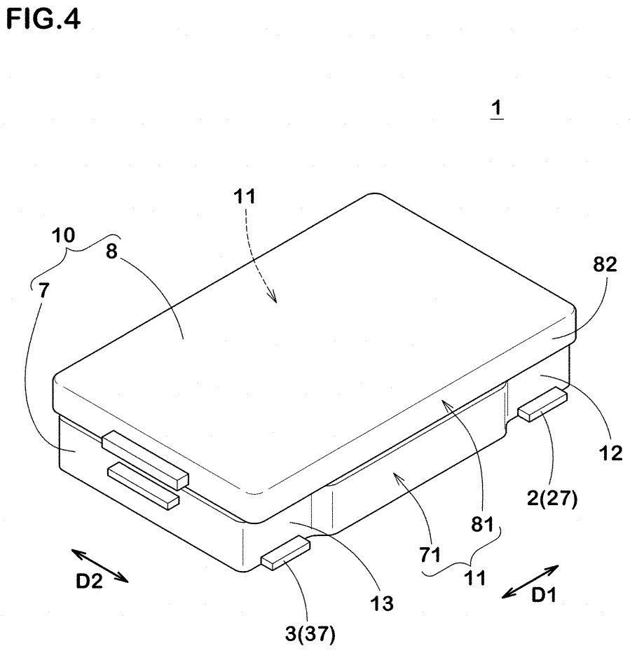

FIG. 4 shows an external configuration of the breaker 1. The case 10 has a pair of side walls 11 extending along the longitudinal direction D1 of the elastic part 43 of the movable piece 4 (or the longitudinal direction of the case 10 itself).

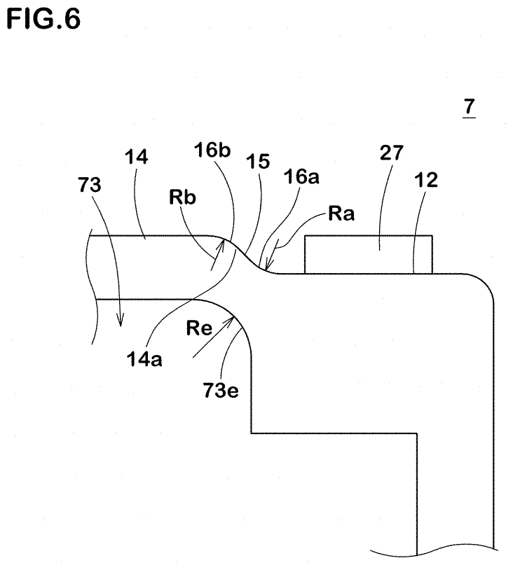

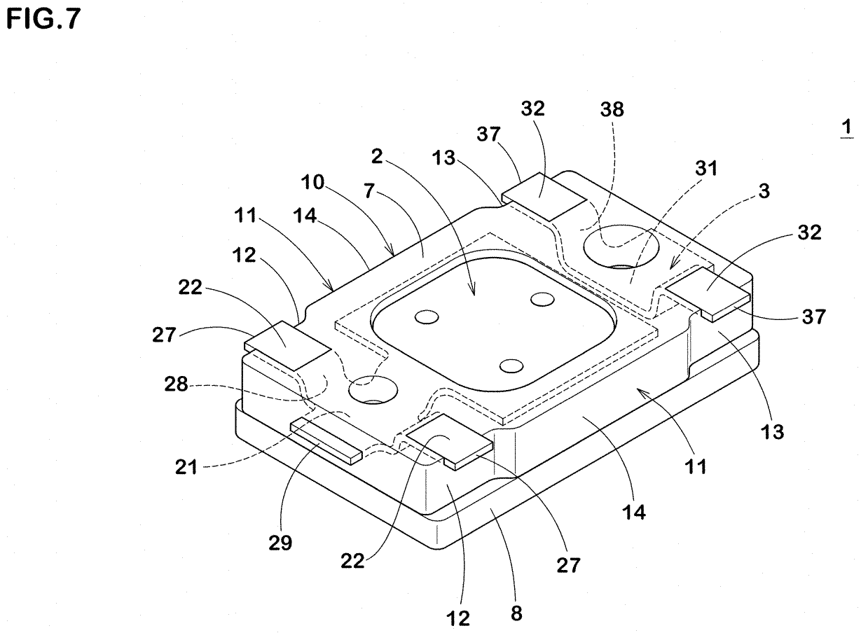

The terminal piece 2 has a pair of protruding portions 27 projecting outwardly of the case 10 from the side walls 11 (see FIGS. 6 and 7). The protruding portions 27 protrude in the short direction D2 of the elastic part 43 (or the short direction of the case 10 itself), and can be connected to an external circuit. Thereby, for example, as compared with a breaker having terminals projecting in the longitudinal direction D1 of the case as disclosed in Patent Document 1, the length of the breaker 1 in the longitudinal direction D1 is suppressed, and the breaker 1 can be easily miniaturized.

The side wall 11 is provided, in its neighboring portion of the protruding portion 27, with a concave portion 12 depressed inwardly of the case 10 (that is, in the short direction D2). Thus, the width in the short direction D2 is suppressed while ensuring the amount of protrusion of the protruding portion 27 from the side wall 11, and the breaker 1 can be miniaturized.

The terminal piece 3 has a pair of protruding portions 37 projecting outwardly of the case 10 from the side walls 11 (see FIGS. 6 and 7). The protruding portions 37 protrude in the short direction D2 and can be connected to an external circuit. Thus, for example, the length dimension of the breaker 1 in the longitudinal direction D1 is suppressed, and the breaker 1 can be easily miniaturized.

The side wall 11 is provided, in its neighboring portion of the protruding portion 37, with a concave portion 13 depressed inwardly of the case 10. Thereby, while ensuring the amount of protrusion of the protruding portion 37 from the side wall 11, the length of the case 10 in the short direction D2 is suppressed, and the breaker 1 can be miniaturized.

In the present embodiment, the protruding portion 27 is formed on the terminal piece 2, and the protruding portion 37 is formed on the terminal piece 3. It may be possible that only one of the terminal pieces 2 and 3 is provided with the protruding portions 27 or 37. In this case, in the side wall 11 in which the protruding portion 27 or 37 does not exist, the concave portion 12 or 13 may be eliminated.

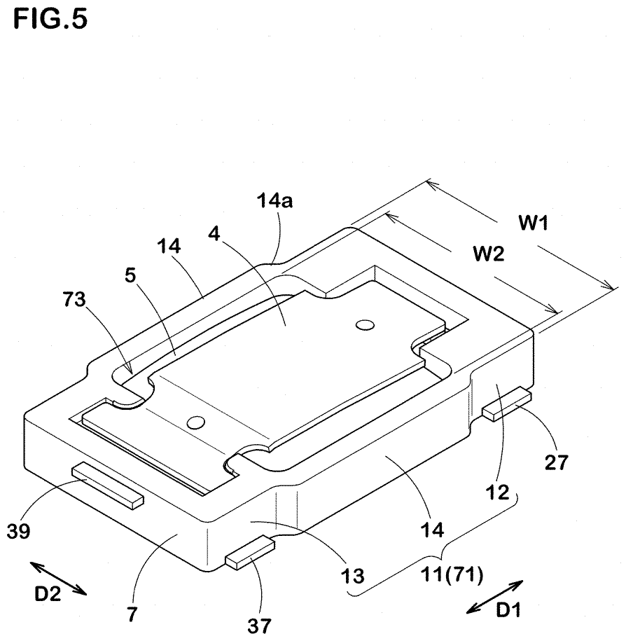

FIG. 5 shows the case main body 7 after the PTC thermistor 6, the thermally-actuated element 5 and the movable piece 4 are sequentially mounted, but before the lid member 8 is mounted. It is preferable that the protruding portions 27 and the protruding portions 37 are disposed on both sides in the longitudinal direction D1 with respect to the thermally-actuated element 5. Thereby, the protruding portions 27, 37 and the thermally-actuated element 5 are arranged without overlapping in the longitudinal direction D1, and interference between the protruding portions 27, 37 and the thermally-actuated element 5 is easily avoided.

It is preferable that the concave portions 12 and the concave portions 13 are arranged on both sides of the housing recess 73 in the longitudinal direction D1. It becomes possible to ensure a sufficient wall thickness for the side walls 11 and then to set a large volume on the housing recess 73 so the large-sized thermally-actuated element 5 can be adopted.

The side wall 11 is provided, around the thermally-actuated element 5, with a convex portion 14 protruding outwardly of the case 10 (that is, in the short direction D2) from the concave portions 12 and 13. Thereby, it is possible to set the width dimension of the housing recess 73 in the short direction D2 larger while securing a sufficient thickness of the side wall 11. Therefore, it is possible to employ the thermally-actuated element 5 having a large width in the short direction D2, and the thermally-actuated element 5 becomes easily-workable. Further, such thermally-actuated element 5 can easily obtain a stable operating temperature and a stable reset temperature, and contributes to the improvement in the temperature characteristics of the breaker 1. As a result, the degree of freedom in selecting the materials constituting the thermally-actuated element 5 is increased, and it becomes possible to form the thermally-actuated element 5 with, for example, materials having more excellent chemical stability or cheaper materials.

The above-described thermally-actuated element 5 having a large width dimension pushes up the movable piece 4 in the direction toward the lid member 8 with a large elastic force generated at the time of the reverse warpage deformation shown in FIG. 3. Along with this, by employing the movable piece 4 having the elastic part 43 having a large width dimension and a large thickness dimension, the contact pressure between the fixed contact 21 and the moving contact 41 can be increased, and it is possible to reduce the resistance value of the breaker 1 in the conductive state shown in FIG. 2 where the fixed contact 21 and the moving contact 41 contact with each other.

As shown in FIG. 4, the side walls 11 include side walls 71 of the case main body 7, and side walls 81 of the lid member 8.

In this embodiment, the concave portions 12 and 13 are formed in the side walls 71 of the case main body 7. Thereby, the length in the short direction D2, of the case main body 7 is suppressed, while securing the amount of protrusion of the protruding portion 37 from the side wall 11, and it becomes possible to reduce the size of the case main body 7 and thus the breaker 1. Also, the convex portion 14 is formed in the side walls 71 of the case main body 7. Thereby, it becomes possible to make the width dimension in the short direction D2, of the housing recess 73 large, and to adopt the large-sized thermally-actuated element 5.

As shown in FIG. 5, the ratio W2/W1 of the distance W1 in the short direction D2 between the pair of concave portions 12 and the width dimension W2 in the short direction D2 of the housing recess 73 is preferably 0.85 to 1.05. When the ratio W2/W1 is less than 0.85, the case main body 7 is enlarged in the short direction D2 in the convex portion 14. On the other hand, when the ratio W1/W1 exceeds 1.05, the thickness of the convex portion 14 (particularly, the thickness of the convex portion 14 at the end portion 14a in the longitudinal direction D1) becomes reduced, which may have an effect on the sealing property and strength of the case 10. When it is desired to ensure a sufficient thickness of the end portion 14a, the case main body 7 is enlarged in the convex portion 14 in the longitudinal direction D1 and the short direction D2. From the above viewpoint, a more desirable range of the ratio W1/W1 is 0.88 to 0.98. The ratio between the distance (not shown) in the short direction D2 between the pair of concave portions 13 and the width dimension W2 in the short direction D2 of the housing recess 73 is the same as described above.

FIG. 6 is an enlarged plan view showing the concave portion 12 of the case main body 7 and the neighboring portion thereof (hereinafter, the description of the concave portion 13 and the neighboring portion thereof is omitted since the configuration thereof is the same). The concave portion 12 and 13 and the convex portion 14 are smoothly connected via an inclined portion 15. This makes it possible to easily secure the thickness of the case main body 7 at the end portion 14a.

A recessed corner portion 16a where the concave portion 12 and the inclined portion 15 intersect is formed in an arc shape in a plan view in the thickness direction of the elastic part 43. A recessed corner 73e of the housing recess 73 for accommodating the rectangular shaped thermally-actuated element 5 is formed in an arc shape in the plan view. That is, the concave portion 12 has, at its end edge portion on the inclined portion 15 side, the fillet shaped recessed corner portion 16a, and the housing recess 73 has two pairs of fillet shaped recessed corners 73e. This makes it possible to easily secure the thickness of the case main body 7 at the end portion 14a. In the present embodiment, the radius Re of curvature of the recessed corner 73e is larger than the radius Ra of curvature of the recessed corner portion 16a. This makes it possible to more easily secure the thickness of the case main body 7 at the end portion 14a.

A protruding corner portion 16b where the convex portion 14 and the inclined portion 15 intersect is formed in an arc shape in the plan view. The radius Rb of curvature of the protruding corner portion 16b is equal to the radius Ra of curvature of the recessed corner portion 16a. Thereby, a mold for molding the case main body 7 can be easily created.

The side walls 81 of the lid member 8 are formed in a planar shape. Such side walls 81 are easy to mold, and the side walls 81 having no irregularities contributes to the miniaturization of the breaker 1.

The end face 82 of the side wall 81 is positioned outside of the concave portions 12 and 13 in the short direction D2. Thereby, the metal plate 9 having a large width in the short direction D2 can be embedded in the lid member 8, and the rigidity of the case 10 can be easily increased. It becomes possible to employ the metal plate 9 having a large width which can cover the thermally-actuated element 5 in the plan view, for example, while sufficiently ensuring the thickness of the side wall 81 on the outside of the metal plate 9, that is, the distance between the end face of the metal plate 9 and the end face 82 of the side wall 81. In addition, it becomes possible to downsize the breaker 1 by suppressing the amount of protruding of the protruding portions 27, 37 from the side wall 81 of the lid member 8 while ensuring the amount of protruding of the protruding portions 27, 37 from the concave portions 12, 13.

With the above configuration, the concave portions 12 and 13 are depressed inwardly of the case 10 from the end face 82 of the side wall 81 of the lid member 8. Thereby, the occupied range of the land of a circuit board constituting an external circuit is reduced, and the degree of freedom in the pattern design is increased. In addition, since the amount of protruding of the protruding portions 27 and 37 from the concave portions 12 and 13 are easily secured, the solder can easily flow along the side surfaces of the concave portions 12 and 13 in a fillet shape. The mechanical connection between the terminals 22 and 32 and the land becomes strong, and the resistance between the two is further reduced.

In this embodiment, the leading ends of the protruding portions 27 and 37 and the leading ends of the convex portion 14 are positioned on the same plane parallel to the longitudinal direction D1 (perpendicular to the short direction D2). Thus, the width dimension (full width dimension) in the short direction D2 of the breaker 1 is suppressed, and the breaker 1 can be miniaturized.

FIG. 7 shows the breaker 1 as viewed from the bottom side of the case main body 7. The concave portions 12 and 13 are disposed at corners of the case 10. As a result, parts such as the thermally-actuated element 5 can be arranged at the center of the case 10 without interfering with the protruding portions 27 and 37. Also, connections between the protruding portions 27 and 37 and the external circuit are facilitated. Further, in a soldering step, it becomes possible to easily determine the position (and posture) of the breaker 1 on the melted solder.

The terminals 22 and 32 are exposed in the bottom surface of the case main body 7 and connected to the land of an external circuit by a method such as soldering. In the present embodiment, a pair of the terminals 22 and a pair of the terminals 32 are respectively arranged side by side in the short direction D2 of the case 10.

In the terminal piece 2 in the present embodiment, a stepwise bent portion 28 is formed between the fixed contact 21 and the terminal 22. The stepwise bent portion 28 is embedded in the case main body 7. The stepwise bent portion 28 connects between the fixed contact 21 and the terminal 22 and arranges the fixed contact 21 and the terminal 22 at different heights. Thereby, it becomes possible to expose the second surface of the terminal 22 in the bottom surface of the case main body 7 irrespective of the height of the fixed contact 21. This facilitates connection with an external circuit.

Similarly, in the terminal piece 3, a stepwise bent portion 38 is formed between the connect portion 31 and the terminal 32. The stepwise bent portion 38 is embedded in the case main body 7. The stepwise bent portion 38 connects between the connect portion 31 and the terminal 32, and arranges the connect portion 31 and the terminal 32 at different heights. Thereby, it becomes possible to expose the second surface of the terminal 32 in the bottom surface of the case main body 7 irrespective of the height of the connect portion 31. This facilitates connection with an external circuit. Further, it becomes possible to gather the terminals 32 in the short direction D2 of the case 10, and the occupied area of the land of an external circuit is reduced, therefore, the degree of freedom in the pattern design is increased.

In order to connect between the terminals 22 and 32 and the land of an external circuit, for example, a reflow soldering method is employed. In the breaker 1, the tips of the terminals 22 and 32 extend outwardly in the short direction D2 of the case main body 7 to protrude from the side walls 71 of the case main body 7 and form the protruding portions 27 and 37. Therefore, the contact area between the terminals 22 and 32 and the land is increased, and the contact resistance therebetween is reduced.

Further, since the solder flows along the end faces of the protruding portions 27 and 37 in a fillet shape, the mechanical connection between the terminals 22 and 32 and the land is strengthened, and the resistance therebetween is further reduced. In the present invention, the above-described stepwise bent portions 28 and 38 may be omitted. In such a case, exposure of the terminals 22 and 32 in the bottom surface of the case main body 7 is prevented. But by changing the amount of protruding of the protruding portions 27 and 37, a contact area between the terminals 22 and 32 and the land can be secured. In this configuration, a stepwise bent portion may be provided on the protruding portions 27 and 37 (that is, outside the case 10), and a board of an external circuit may be provided with an opening, cutout or the like for avoiding interference with the case main body 7.

The breaker 1 according to the present invention is not limited to the configuration of the above-described embodiment. It can be implemented in various embodiments. That is, it is enough for the breaker 1 to have at least: the fixed contact 21; the movable piece 4 which has the elastic part 43 formed in a plate shape and elastically deformable, and the moving contact 41 in one end portion of the elastic part 43, and which presses the moving contact 41 against the fixed contact 21 to contact therewith; the thermally-actuated element 5 which is deformed with a change in the temperature and which actuates the movable piece 4 so that the moving contact 41 is separated from the fixed contact 21; the case 10 which houses the movable piece 4 and the thermally-actuated element 5; and the terminal piece 2 or 3 to be electrically connected to an external circuit, wherein the case 10 has the side wall 11 extending along the longitudinal direction of the elastic part 43, the terminal piece 2 or 3 has the protruding portion 27 or 37 projecting from the side wall 11 toward the outside of the case 10, and the side wall 11 has the concave portion 12 or 13 depressed inwardly of the case 10 in the neighboring portion of the protruding portion 27 or 37.

For example, the method of joining the case main body 7 and the lid member 8 is not limited to the ultrasonic welding. A method by which the two are firmly joined may be appropriately adopted. For example, the two may be adhered by applying and filling a liquid or gel adhesive and curing the adhesive. Further, the case 10 is not limited to the configuration constituted by the case main body 7 and the lid member 8 and the like, but may be constituted by two or more parts.

The case 10 may be sealed with a resin or the like by secondary insert molding or the like in a state where the terminals 22 and 32 are exposed. Thereby, the airtightness of the case 10 is further enhanced.

Further, the movable piece 4 may be formed of a laminated metal such as a bimetal or a trimetal, so that the movable piece 4 and the thermally-actuated element 5 may be integrally formed. In this case, the structure of the breaker is simplified, and the size can be further reduced.

Also, the present invention may be applied to the configuration as shown in WO2011/105175, in which terminal piece 3 and movable piece 4 are integrally formed.

The present embodiment is provided with the self-holding circuit using the PTC thermistor 6, but an embodiment in which such configuration is omitted can be applied. In such a configuration, the height of the breaker 1 is reduced, and the size can be further reduced.

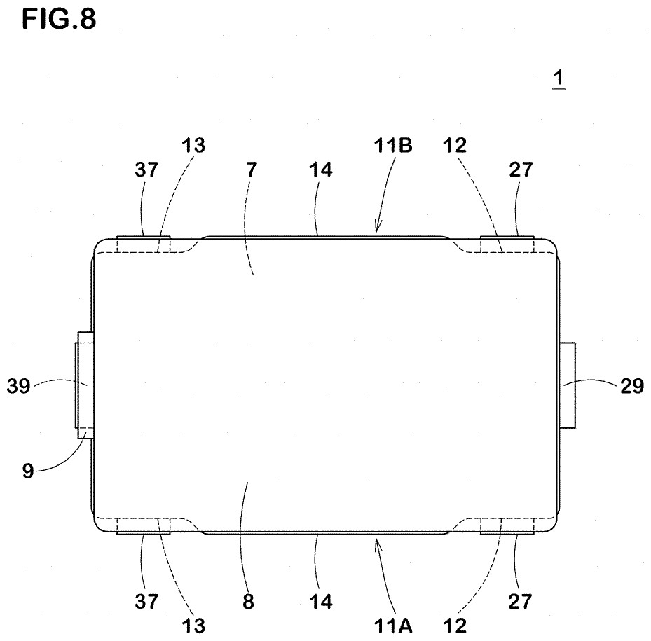

Further, the terminal piece 2 may have a protruding portion 29 protruding outwardly from a side wall of the case 10 extending along the short direction D2 as shown in FIG. 8. In such terminal piece 2, the accuracy of the posture and positioning of the terminal piece 2 can be improved by bringing the terminal piece 2 in contact with the mold at the protruding portions 27 and 29 when the terminal piece 2 is inserted into a mold and the case main body 7 is injection-molded. Similarly, the terminal piece 3 may have a protruding portion 39 protruding outwardly from a side wall of the case 10 extending along the short direction D2. As the accuracy of the posture and positioning of the terminal pieces 2 and 3 is improved by the protruding portions 27 and 29 and the protruding portions 37 and 39, the relative positional relationship between the fixed contact 20 and the moving contact 41 is accurately maintained, and the breaker 1 having excellent temperature characteristics can be easily manufactured.

The protruding portions 27 and 29 and the protruding portions 37 and 39 may be formed so that the amount of protruding from the case 10 is more than the embodiment shown in FIG. 8. In this case, it may be possible to cut off each tip end portion after the case main body 7 and the lid member 8 are welded.

In FIG. 8, the protruding portion 27 may be formed on one of the side walls (for example, 11A). In this case, the protruding portion 37 may be formed on the one of the side walls (11A) or the other of the side walls (11B). In the side wall where the protruding portions 27 and 37 do not exist, the concave portions 12 or 13 may be eliminated.

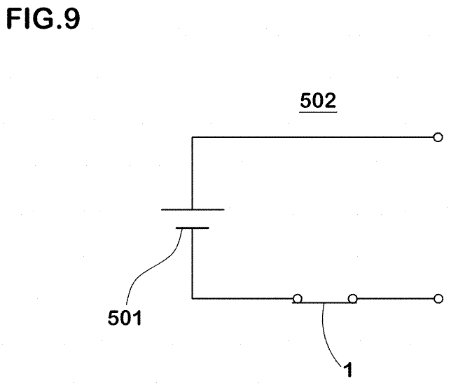

The breaker 1 according to the present invention can be widely applied to secondary battery packs, safety circuits for electric equipment and the like. FIG. 9 shows a safety circuit 502 for an electrical equipment. The safety circuit 502 includes the breaker 1 in series in an output circuit of a secondary battery 501.

Furthermore, the breaker 1 according to the present invention is also applicable to the connector disclosed in Japanese Patent Application Publication No. 2016-225142. In this case, it is possible to easily reduce the size of the connector. Further, a part of the safety circuit 502 may be constituted by a cable including the connector including the breaker 1.

### EXPLANATION OF REFERENCE SIGNS

1: breaker
2: terminal piece
3: terminal piece
4: movable piece
5: thermally-actuated element
7: case main body (first case)
8: lid member (second case)
10: case
11: side wall
12: concave portion
13: concave portion
14: convex portion
21: fixed contact
27: protruding portion
37: protruding portion
41: moving contact
43: elastic part
81: side wall
501: secondary battery
502: safety circuit
D1: longitudinal direction
D2: short direction

1. A breaker comprising:
a fixed contact,
a movable piece which has an elastic part formed in a plate shape and being elastically deformable and a moving contact disposed in one end portion of the elastic part, and which presses the moving contact against the fixed contact so that the moving contact contacts with the fixed contact,
a thermally-actuated element deforming with a change in the temperature of the thermally-actuated element to actuate the movable piece so that the moving contact is separated from the fixed contact,
a case housing the movable piece and the thermally-actuated element, and
a terminal piece to be electrically connected to an external circuit,
wherein:
the case has a side wall extending along a longitudinal direction of the elastic part,
the terminal piece has a protruding portion which protrudes from the side wall toward the outside of the case, and
the side wall is provided, in its neighboring portion of the protruding portion, with a concave portion which dents inwardly of the case,
wherein:
the case includes:
a first case provided with a housing recess for accommodating the movable piece and the thermally-actuated element, and
a second case attached to the first case and covering the housing recess, and
wherein:
the first case has a part of said side wall, and the second case has another part of said side wall, and
the concave portion is formed in said a part of said side wall of the first case, and
the concave portion dents inwardly of the case from said another part of said side wall of the second case.

2. The breaker as set forth in claim 1, wherein the protruding portion is disposed on each side in the longitudinal direction with respect to the thermally-actuated element.

3. The breaker as set forth in claim 2, wherein the side wall is provided, in its neighboring portion of the thermally-actuated element, with a convex portion protruding outwardly of the case from the concave portion.

4. (canceled)

5. The breaker as set forth in claim 1, wherein said a part of the side wall of the second case is formed in a planar shape.

6. (canceled)

7. The breaker as set forth in claim 1, wherein the concave portion and the housing recess each have an recessed corner portion in a fillet shape, and a radius of curvature of the recessed corner portion of the housing recess is larger than a radius of curvature of the recessed corner portion of the concave portion.

8. The breaker as set forth in claim 3, wherein a leading end of the protruding portion and a leading end of the convex portion are positioned on a plane parallel to the longitudinal direction.

9. The breaker as set forth in claim 1, wherein the case is formed in a rectangular shape having long sides in the longitudinal direction of the elastic part when viewed in the thickness direction of the elastic part, and the concave portion is disposed in a corner portion of the case.

10. A safety circuit for an electrical equipment, comprising the breaker as set forth in claim 1.
